(19) United States
(12) Patent Application Publication
(10) Pub. No.: US 2025/0149716 A1
(43) Pub. Date: May 8, 2025

(54) IN-VEHICLE BATTERY PACK

(71) Applicant: TOYOTA JIDOSHA KABUSHIKI KAISHA, Toyota-shi (JP)

(72) Inventors: Daiki Kawachino, Miyoshi-shi (JP); Shigeyuki Mori, Nagoya-shi (JP); Takuma Komatsu, Toyota-shi (JP); Yuusuke Iida, Toyota-shi (JP); Ayame Warita, Toyota-shi (JP); Sakuya Uchiyama, Toyota-shi (JP); Nobuyasu Nishiki, Toyokawa-shi (JP)

(73) Assignee: TOYOTA JIDOSHA KABUSHIKI KAISHA, Toyota-shi (JP)

(21) Appl. No.: 18/775,381

(22) Filed: Jul. 17, 2024

(30) Foreign Application Priority Data
Nov. 2, 2023 (JP) 2023-188320

(51) Int. Cl. H01M 50/262; H01M 50/249

(52) U.S. Cl. CPC H01M 50/262; H01M 50/249

(57) ABSTRACT

An in-vehicle battery pack according to the present disclosure is an in-vehicle battery pack including a bracket provided at either the front side or the rear side of the battery pack, wherein the bracket has at least two fastening portions, a first fastening portion is fastened to a floor reinforcement, a second fastening portion is fastened, at a position below the first fastening portion, to a floor bracket fastened to a floor panel, and the first fastening portion and the second fastening portion are located at different positions in a width direction of the bracket.

### CROSS-REFERENCE TO RELATED APPLICATION

This application claims priority to Japanese Patent Application No. 2023-188320 filed on Nov. 2, 2023, incorporated herein by reference in its entirety.

### BACKGROUND

### 1. Technical Field

The present disclosure relates to in-vehicle battery packs.

### 2. Description of Related Art

Japanese Unexamined Patent Application Publication No. 2022-111787 (JP 2022-111787 A) discloses an in-vehicle battery pack including shock absorbing portions.

### SUMMARY

A technique of providing a shock absorbing portion to protect a battery pack against an impact applied to a vehicle has been developed. JP 2022-111787 A discloses a battery pack in which a tray for placing a battery includes a frame having an easily deformable portion. When an impact is applied to a vehicle, a shock absorbing portion is deformed downward with respect to a battery region to protect the battery region.

However, when a load of a collision from a side (hereinafter referred to as “side-impact collision”) is applied and a floor panel collapses, the root portion of a center tunnel where pipes and wires are arranged tends to move downward. At this time, the floor panel may come into contact with the upper surface of the battery pack.

The present disclosure was made to solve such an issue, and an object of the present disclosure is to provide an in-vehicle battery pack that can reduce interference between a floor panel and a battery when a side impact load is applied.

An in-vehicle battery pack according to the present disclosure includes a bracket provided at either a front or rear side of the battery pack.

The bracket includes at least two fastening portions.
A first fastening portion is fastened to a floor reinforcement.
A second fastening portion is fastened, at a position below the first fastening portion, to a floor bracket fastened to a floor panel.
The first fastening portion and the second fastening portion are located at different positions in a width direction of the bracket.
With this configuration, it is possible to provide an in-vehicle battery pack that can reduce interference between a floor panel and a battery when a side impact load is applied.

The first fastening portion and the second fastening portion may be located at a same distance from a center of gravity of the battery pack. With this configuration, the same load is applied to each fastening portion, and unevenness can be reduced.

The second fastening portion may be located closer to an exhaust pipe than the first fastening portion. With this condition, the second fastening portion can be located on the side where a sufficient distance from the outside of a vehicle is provided by the exhaust pipe.

The present disclosure can provide an in-vehicle battery pack that can reduce interference between a floor panel and a battery when a side impact load is applied in the event of a vehicle collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a perspective view of an in-vehicle battery pack according to an embodiment of the present disclosure;

FIG. 1B is a perspective view of an in-vehicle battery pack according to an embodiment of the present disclosure;

FIG. 1C is a cross-sectional view of an in-vehicle battery pack according to the present disclosure;

FIG. 2 is a top view, a cross-sectional view, and a perspective view of an in-vehicle battery pack according to the present disclosure;

FIG. 3A is a perspective view of an in-vehicle battery pack according to an embodiment of the present disclosure;

FIG. 3B is a perspective view of an in-vehicle battery pack according to an embodiment of the present disclosure;

FIG. 3C is a cross-sectional view of an in-vehicle battery pack according to the present disclosure; and

FIG. 4 is a top view of an in-vehicle battery pack according to the present disclosure.

### DETAILED DESCRIPTION OF EMBODIMENTS

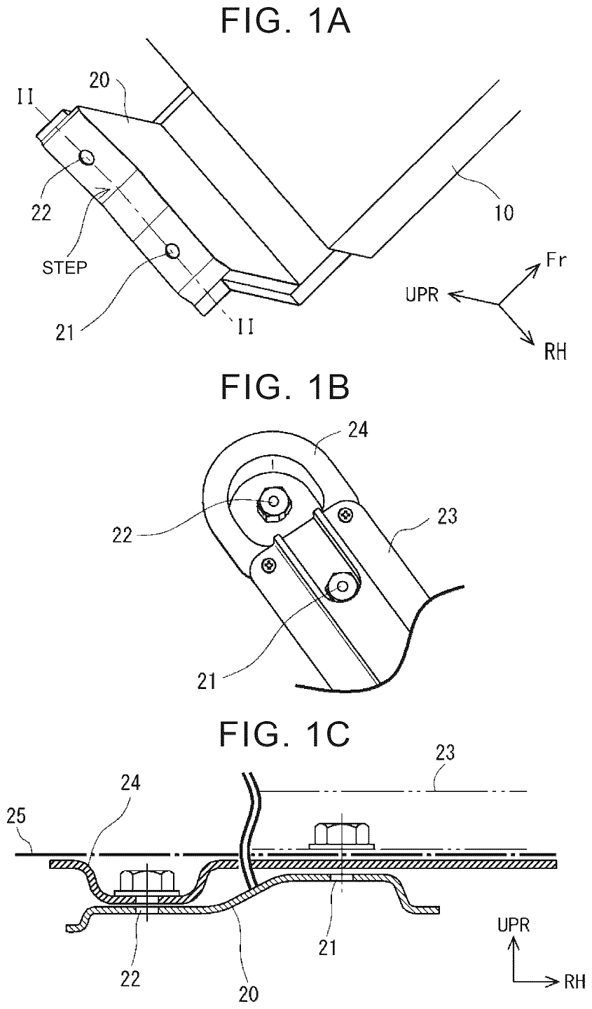

An exemplary configuration of an in-vehicle battery pack (hereinafter referred to as a “battery pack”) according to the present disclosure will be described with reference to FIGS. 1A, 1B, and 1C. The battery pack 10 illustrated in a perspective view of FIG. 1A is an in-vehicle battery pack that is mounted under a floor of a vehicle, and includes a bracket 20 and is attached to the vehicle by the bracket 20.

The bracket 20 includes a stepped portion and at least two fastening portions provided at different positions so as to sandwich the stepped portion in the widthwise direction of the bracket 20 (corresponding to “RH” in the drawing). Here, the fastening portion located above the perspective view (corresponding to “UPR” in the drawing) is referred to as a first fastening portion 21, and the fastening portion located below is referred to as a second fastening portion 22.

Note that, in the present embodiment, the bracket 20 is described as a rear bracket provided on the rear side of the battery pack 10 (corresponding to the opposite direction of the “Fr” in the drawing), but the present disclosure is not limited thereto. The bracket 20 can also be suitably used as a front bracket provided on the front side (corresponding to “Fr” in the drawing) of the battery pack 10.

FIG. 1B is a diagram illustrating an exemplary configuration of the floor reinforcement 23 and the floor bracket 24 fastened to the bracket 20. FIG. 1C is a cross-sectional view of the bracket 20, the floor reinforcement 23, and the floor bracket 24 fastened to each other via the floor panel 25, and shows a cross-section in a dashed-dotted line II-II shown in FIG. 1A.

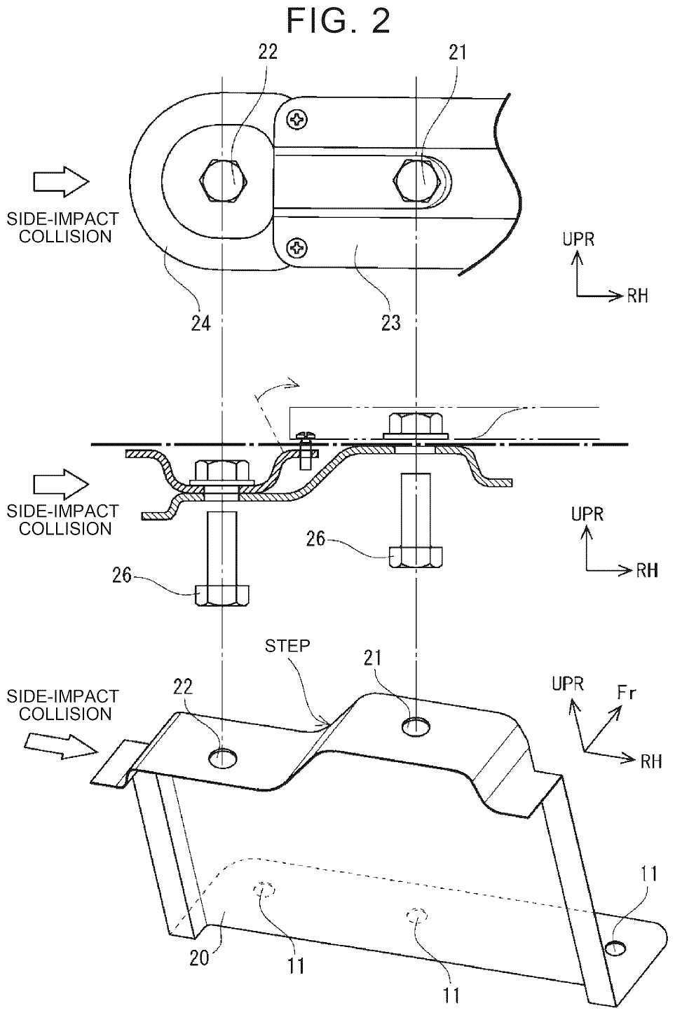

Next, details of the bracket 20, the floor reinforcement 23, and the floor bracket 24 according to the present disclosure will be described with reference to the upper and lower drawings in FIG. 2. Although the description of the battery pack 10 is omitted in the lower view of FIG. 2, it is fastened to the bracket 20 at the battery pack attachment point 11.

The floor bracket 24 is preferably mounted on the side that receives the side impact load (side indicated by the arrow in FIG. 2). Further, the floor reinforcement 23 is preferably mounted on the opposite side of the floor bracket 24 so as to suppress deformation in the width direction when a side impact load is applied.

For example, in plug-in hybrid electric vehicle (PHEV: Plug-in Hybrid Electric Vehicle), RH is secured by disposing an exhaust pipe on RH side. Therefore, the effect of the side impact load is relatively small on RH side. Therefore, the floor bracket 24 is preferably mounted on the side opposite to RH side in which the influence of the side impact load is greater, so that the second fastening portion 22 is disposed at a position closer to the exhaust pipe than the first fastening portion 21.

The bracket 20 has a step between the first fastening portion 21 and the second fastening portion 22, as shown in the lower view of FIG. 2. This makes it possible to induce a twist on the side to which the side impact load is applied.

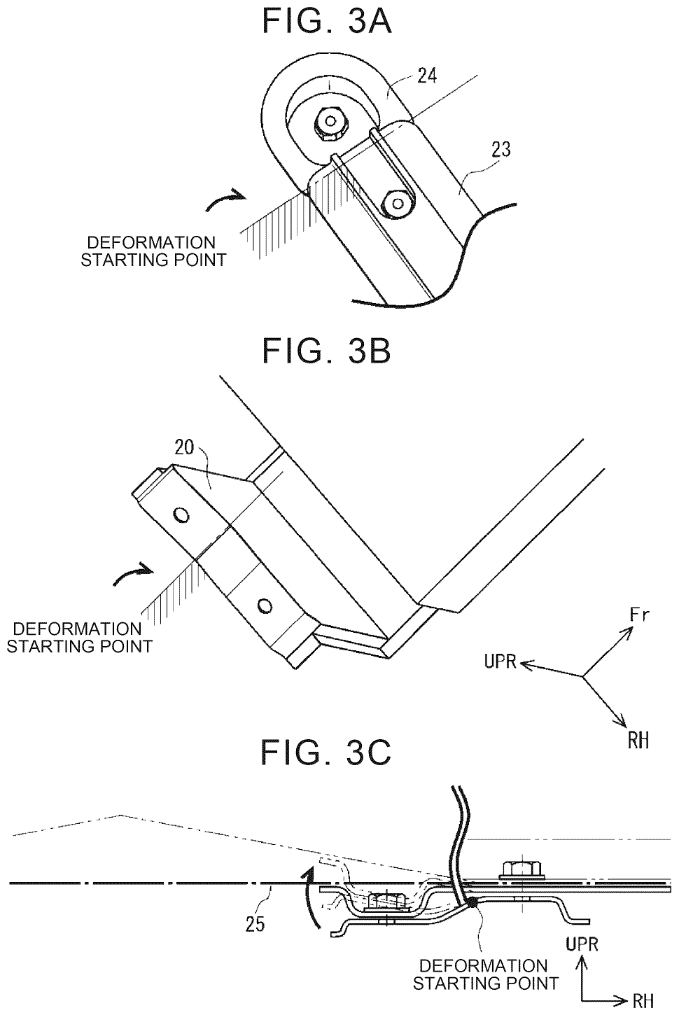

Here, the modification of the bracket 20, the floor reinforcement 23, the floor bracket 24, and the floor panel 25 when the side impact load is applied will be described with reference to FIGS. 3A, 3B, and 3C. The deformation base point shown in FIGS. 3A, 3B, and 3C represents a base point at which the bracket 20, the floor reinforcement 23, the floor bracket 24, and the floor panel 25 are rotationally deformed in the direction indicated by the arrow when the side impact load is applied.

As shown in FIG. 3A, when the side impact load is applied, the floor reinforcement 23 and the floor bracket 24 can be rotated with the boundary as a base point, thereby suppressing the deformation progress of the floor reinforcement 23.

As shown in FIG. 3B, when the side impact load is applied, the bracket 20 rotates with the root part of the step as a base point, so that the deformation progress of the bracket 20 can be suppressed in the second fastening portion 22.

As shown in FIG. 3C, when the side impact load is applied, the floor panel 25 rotates so as to lift UPR from the deformation base point. As a result, it is possible to prevent the floor panel 25 and the battery pack 10 from interfering with each other in a direction opposite to UPR, that is, due to the downward projection.

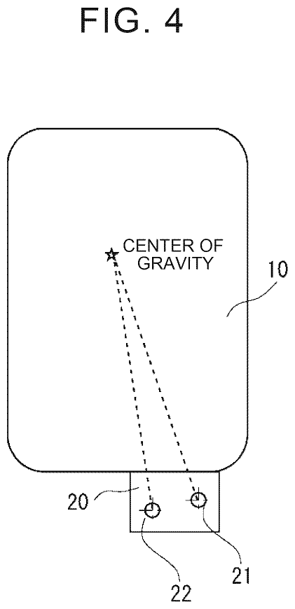

Further, as shown in the top view of the battery pack 10 of FIG. 4, the first fastening portion 21 and the second fastening portion 22 of the bracket 20 are preferably arranged such that the distance from the center of gravity of the battery pack 10 is equal to each other.

The spot hitting points of the floor reinforcement 23, the floor bracket 24, and the floor panel 25 around the first fastening portion 21 and the second fastening portion 22 are substantially equal to each other in consideration of the diverting flow at the time of spot welding. When a large load is applied to the side where the rotation is performed, the rotation can be induced more, and thus the lifting amount of the floor panel 25 increases. On the other hand, since the load at the floor panel 25 and the spot hitting point increases, the spot peeling and the perforation of the floor panel 25 are connected.

On the other hand, by providing the first fastening portion 21 and the second fastening portion 22 such that the distance from the center of gravity of the battery pack 10 is equal, the moment becomes equal. Therefore, the same load can be applied to the first fastening portion 21 and the second fastening portion 22. Therefore, since the load on the floor panel 25 and the spot hitting point can be equalized, the side impact load can be received at the second fastening portion 22 and the progress of the side-impact collision can be suppressed while suppressing the spot peeling and the perforation of the floor panel 25.

In this way, it is possible to provide an in-vehicle battery pack capable of suppressing interference between the floor panel and the battery when a side impact load is applied.

The present disclosure is not limited to the above, and can be appropriately modified without departing from the scope of the present disclosure.

What is claimed is:

1. An in-vehicle battery pack including a bracket provided at either a front or rear side of the battery pack, wherein
the bracket includes at least two fastening portions,
a first fastening portion is fastened to a floor reinforcement,
a second fastening portion is fastened, at a position below the first fastening portion, to a floor bracket fastened to a floor panel, and
the first fastening portion and the second fastening portion are located at different positions in a width direction of the bracket.

2. The in-vehicle battery pack according to claim 1, wherein the first fastening portion and the second fastening portion are located at a same distance from a center of gravity of the battery pack.

3. The in-vehicle battery pack according to claim 1, wherein the second fastening portion is located closer to an exhaust pipe than the first fastening portion.
